(19) United States
(12) Patent Application Publication
(10) Pub. No.: US 2015/0020001 A1
(43) Pub. Date: Jan. 15, 2015

(54) DISPLAY APPARATUS AND CONTROL METHOD OF THE SAME

(71) Applicant: SAMSUNG ELECTRONICS CO., LTD., Suwon-si (KR)

(72) Inventors: Jin-woo HONG, Suwon (KR); Woo-seok KIM, Bucheon (KR); Young-min PARK, Seongnam (KR)

(21) Appl. No.: 14/298,671

(22) Filed: Jun. 6, 2014

(30) Foreign Application Priority Data
Jul. 15, 2013 (KR) 10-2013-0082950

(51) Int. Cl. H04L 29/08

(52) U.S. Cl. CPC H04L 67/22
USPC 715/753

(57) ABSTRACT

Apparatuses and methods related to a display apparatus and a control method of the same are provided. More particularly, the apparatuses and methods relate to a display apparatus which displays a common service for a plurality of user accounts and a control method of the same. A display apparatus includes: a communication section which communicates with a server offering a predetermined account service; a user input section which receives a login by a user of a user account with regard to the account service; a controller which determines whether to display combination service information where account service information corresponding to the user and account service information corresponding to at least one user different from the user are combined; and a display section which displays the combination service information based on the determination.

### CROSS-REFERENCE TO RELATED APPLICATION

This application claims priority from Korean Patent Application No. 10-2013-0082950, filed on Jul. 15, 2013 in the Korean Intellectual Property Office, the disclosure of which is incorporated herein by reference.

### BACKGROUND

1. Field

Apparatuses and methods consistent with the exemplary embodiments relate to a display apparatus and a control method of the same, and more particularly to a display apparatus which displays a common service for a plurality of user accounts and a control method of the same.

2. Description of the Related Art

Recently, a display apparatus accesses an external account service server and is offered an account service, such as a social network service (SNS), in which respective services are given or provide in accordance with user accounts.

For example, if an account A logs on, a service screen for the account A is displayed. Also, if an account B logs on, a service screen for the account B is displayed.

Meanwhile, in the case where a plurality of users activate their own accounts, if a plurality of account service contents corresponding to the plurality of user accounts are displayed based on a predetermined reference, for example, displayed together on one screen, for example, on one time line, it will be convenient for the plurality of users to share the account service contents with one another.

### SUMMARY

One or more exemplary embodiments may provide a display apparatus and a control method of the same, in which if a plurality of users activate their own accounts with regard to a predetermined account service, account service contents can be shared among the plurality of users.

According to an aspect of another exemplary embodiment, a method of controlling a display apparatus is provided including: allowing a (first) user of a user account to log in with regard to a predetermined account service; determining whether to display combination service information where account service information corresponding to the user and account service information corresponding to at least one user different from the user or second user are combined; and displaying the combination service information based on the determination.

According to an aspect of another exemplary embodiment, the determining whether to display the combination service information may determines whether a user account of at least one user different from the user logs in with regard to the account service.

According to an aspect of another exemplary embodiment, the method may be provided further including: determining whether at least one of the user account and the at least one user account different from the user logs out; and displaying second combination service information where the account service information respectively corresponding to other user accounts except the logged-out user account are combined.

According to an aspect of another exemplary embodiment, the determining whether to display the combination service information may include determining whether to display the combination service information based on an account addition command input through a user input section for at least one user different from the user.

According to an aspect of another exemplary embodiment, the method may be provided further including: determining whether an account exclusion command is input for at least one of the user and at least one user different from the user; and displaying second combination service information where the account service information respectively corresponding to other user accounts, except for the user account corresponding to the account exclusion command, are combined.

According to an aspect of another exemplary embodiment, the method may be provided further including: receiving the combination service information, where the account service information corresponding to the user and the account service information corresponding to at least one user different from the user are combined, from a server offering the account service.

According to an aspect of another exemplary embodiment, the method may be provided further including: respectively receiving the account service information corresponding to the user and the account service information corresponding to at least one user different from the user from a server offering the account service; and generating the combination service information based on the respectively received account service information.

According to an aspect of another exemplary embodiment, the combination service information may include at least one of time combination service information and space combination service information.

The foregoing and/or other aspects of exemplary embodiments may be achieved by providing a display apparatus including: a communication section which communicates with a server offering a predetermined account service; a user input section which receives a login of a user account with regard to the account service; a controller which determines whether to display combination service information where account service information corresponding to the user and account service information corresponding to at least one user different from the user are combined; and a display section which displays the combination service information based on the determination.

According to an aspect of another exemplary embodiment, the controller may determine whether at least one user account different from the user logs-in with regard to the account service, and control the combination service information to be displayed when the at least one user account different from the user logs in with regard to the account service.

According to an aspect of another exemplary embodiment, the controller may determine whether at least one of the user account and at least one user account different from the user logs out, and control second combination service information, where account service information respectively corresponding to other user accounts except the determined logged-out user account are combined, to be displayed.

According to an aspect of another exemplary embodiment, the controller may determine whether an account addition command is input for at least one user different from the user through the user input section, and control the combination service information to be displayed when the account addition command is input.

According to an aspect of another exemplary embodiment, the controller may determine whether an account exclusion command is input for at least one of the user and at least one user different from the user through the user input section, and control second combination service information, where account service information respectively corresponding to the other user accounts except a user account corresponding to the account exclusion command are combined, to be displayed.

According to an aspect of another exemplary embodiment, the controller may control the communication section to receive the combination service information, where the account service information corresponding to the user and the account service information corresponding to at least one user different from the user are combined, from a server offering the account service.

According to an aspect of another exemplary embodiment, the display apparatus may be provided further including a combination service information generator, wherein the controller controls the communication section to receive account service information corresponding to the user and account service information corresponding to at least one user different from the user respectively from a server offering the account service, and controls the combination service information generator to generate the combination service information based on the received account service information of the respective users.

According to an aspect of another exemplary embodiment, the combination service information may include at least one of time combination service information and space combination service information.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display system according to an exemplary embodiment;

FIG. 2 is a block diagram showing a configuration of a display apparatus according to an exemplary embodiment;

FIGS. 3 to 8 illustrate examples of screens displaying account service information according to an exemplary embodiment; and

FIG. 9 is a flowchart showing a control method of the display apparatus according to an exemplary embodiment.

### DETAILED DESCRIPTION OF EXEMPLARY EMBODIMENTS

Below, exemplary embodiments will be described in detail with reference to accompanying drawings so as to be easily realized and understood by a person having ordinary knowledge or skill in the art. The exemplary embodiments may be embodied in various forms without being limited to the exemplary embodiments set forth herein. Descriptions of well-known parts are omitted for clarity, and like reference numerals refer to like elements throughout.

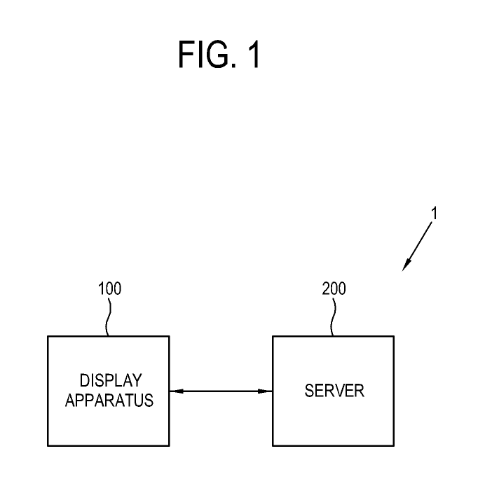

FIG. 1 schematically shows a display system according to an exemplary embodiment.

Referring to FIG. 1, a display system 1 may be achieved in the form of including a display apparatus 100 and an account service server 200.

The display apparatus 100 may be achieved by an apparatus that can access Internet, for example, by a television (TV) such as Internet protocol TV, a notebook computer, a tablet personal computer (PC), a cellular phone, etc. that can access an external account service server 200 and receive and offer account service information such as a social network service (SNS) message.

Here, the IPTV refers to a TV that can offer an information service, moving picture contents, broadcasting, etc. through Internet.

The account service server 200 refers to a server that can offer an account service such as a social network service (SNS).

The SNS is a service where an individual can enter into a relation with others in cyber space on the Internet, that is, a service of providing communication to share a variety of information. Representatively, there are Mini Homepy, Blog, Cafe, Twitter, Facebook, etc. provided by Cyworld, Naver, Daum, etc.

An account service user creates his/her own account on a site that provides the account service such as the SNS, and is offered the account service.

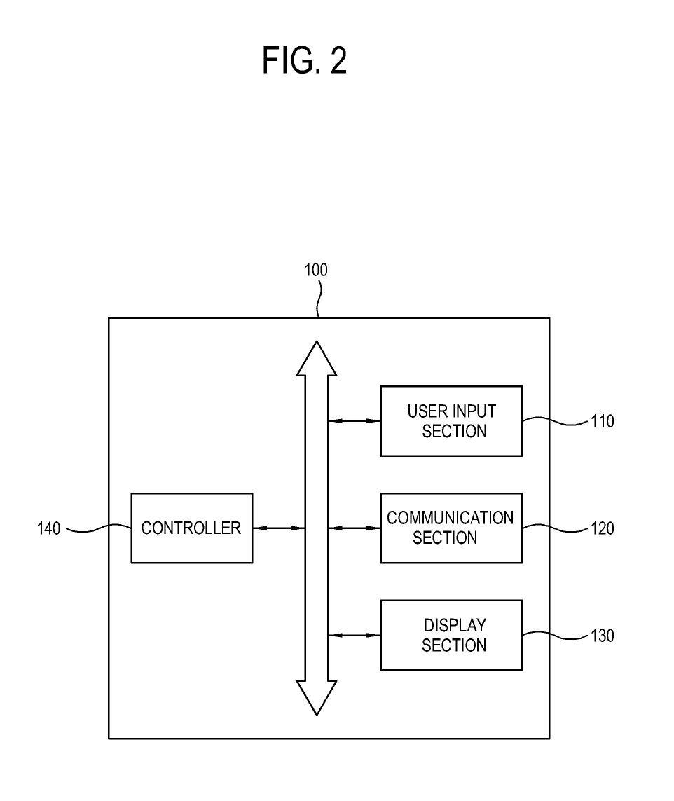

FIG. 2 is a block diagram showing a configuration of a display apparatus according to an exemplary embodiment.

As shown in FIG. 2, a display apparatus 100 includes a user input section 110, a communication section 120, a display section 130, and a controller 140.

The user input section 110 transmits various preset control commands or non-limited information to the controller 140 in accordance with a user's control or input. The user input section 110 may be achieved by a menu key and an input panel placed outside the display apparatus 100, or a remote controller separated from the display apparatus 100, etc.

Alternatively, the user input section 110 and the display section 130 may be formed as a single body. That is, if the display section 130 is a touch screen, a user may transmit the preset command to the controller 140 through an input menu (not shown) displayed on the display section 130.

The user input section 110 receives login and/or logout for activating and/or inactivating a user account of the account service provided by the account service server from a user.

Also, the user input section 110 may receive a login of at least one user different from the login user or from several different users.

Further, the user input section 110 may receive a logout for at least one user account among the plurality of user accounts that are logged in.

The user input section 110 may receive an account addition command from a user so that the controller 140 can determine whether to display the combination service information. That is, after receiving a login of one user account with regard to a predetermined account service, the account addition command may be received with regard to at least one user different from the logged in user.

Also, the user input section 110 may receive an account exclusion command with regard to at least one account between the login user and a user added by the account addition command.

Also, the account exclusion command may be received with regard to at least one among the plurality of logged-in users.

The communication section 120 communicates with the account service server providing a predetermined account service, and transmits and receives data and a control command to and from the server, which may be achieved in the form of accessing the Internet through various networks.

If the user of an account of one user logs in through the user input section 110, the communication section 120 requests the account service server corresponding to the account to give the account service information of the user and receive the account service information from the account service server under control of the controller 140.

Also, if the user account different from the one user account logs in through the user input section 110, the communication section 120, the communication section 120 requests the account service information of the different user account and receives the account service information of or corresponding to the different user from the account service server.

Here, there may be provided a plurality of user accounts different from the one user account, and the account service information may be received corresponding to a plurality of users.

Also, if the account addition command is received through the user input section 110 with regard to at least one user different from the one user. The communication section 120 requests the account service server to give or provide the account service information corresponding to each of the at least one user or users, and receives each account service information.

Also, the communication section 120 according to an exemplary embodiment requests the account service server to give combination service information where the account service information corresponding to the logged-in user and the account service information corresponding to at least one user different from the above user are combined, and receives the combination service information from the account service server under control of the controller 140.

Also, if the account exclusion command is received through the user input section 110 with regard to at least one between the login user and at least one user different from the login user, the communication section 120 requests the account service server to give second combination service information where the account service information respectively corresponding to the other user accounts, except the excluded user account, are combined, and receives the second combination service information from the account service server

The display section 130 displays an image based on a video signal output from an image processing section (not shown). The display section 130 may include a display panel (not shown) such as a liquid crystal display (LCD), a plasma display panel (PDP), an organic light emitting diode (OLED), etc. on which an image is displayed, and a panel driver (not shown) which performs timing control for displaying the video signal on the display panel.

Also, the display section 130 may be achieved by a touch screen for sensing touch. Here, the touch screen refers to a screen that directly receives input data so that when a certain position or a letter displayed on the screen is touched with a user's finger or other object without using any separate input device, the position can be determined and specifically processed by stored software.

The touch screen may be achieved by attaching a touch panel to a general display screen. Here, the touch panel includes a panel that employs a film for detecting electrostatic capacity to determine a contact position of a hand or other objects having an electrostatic charge, a panel that employs vertical and horizontal infrared beams to form a lot of rectangular lattices on the screen and determine a contact position when a hand or other objects contacts the lattices, or the like panel.

In this case, the display section 120 outputs a touch signal due to a user's contact to the controller 140. Here, the user's contact may be based on other various objects as well as a user's hand.

The display section 130 according to an exemplary embodiment displays a user interface (UI) for receiving login and/or logout by a user of the user account with regard to the account service.

Also, the display section 130 displays a UI for receiving the account addition command with regard to at least one user.

Also, the display section 130 displays a UI for receiving the account exclusion command with regard at least one user.

The display section 130 displays the account service information received from the account service server under control of the controller 140.

The display section 130 may display the combination service information received from the account service server.

The display section 130 may display the second combination service information received from the account service server.

The display section 130 may display the combination service information generated by a combination service information generator (not shown) under control of the controller 140.

The display section 130 may display the second combination service information generated by a combination service information generator (not shown) under control of the controller 140.

The controller 140 controls general operations of the user input section 110, the communication section 120, and the display section 130.

The controller 140 according to an exemplary embodiment determines whether to display the combination service information, in which the account service information corresponding to the login user and the account service information corresponding to at least one user different from the user are combined, after a user of a user account logs in with regard to the account service.

Here, the controller 140 determines whether at least one user of an account different from the login user logs in with regard to the account service, and displays the combination service information when the user account of the at least one user logs in.

If it is determined to display the combination service information, the controller 140 controls the communication section 120 to request the account service server to give or provide the combination service information, and receive the combination service information from the account service server, so that the combination service information can be displayed by the display section 130. For example, if it is determined that a user account A logs in and then the user account B logs in with regard to the account service, the controller 140 requests the account service server to give or provide the combination service information where the account service information corresponding to the user account A and the account service information where the user account B are combined, and controls the combination service information to be received and displayed.

Here, if it is determined that the user account C logs in with regard to the account service, the controller 140 requests the account service server to give or provide the combination service information where the account service information corresponding to the user account A, the account service information corresponding to the user account B, and the account service information corresponding to the user account C are all combined, and controls the combination service information to be received and displayed.

Also, the controller 140 determines whether at least one among the plurality of user accounts logs out or not in the state that the combination service information corresponding to the plurality of users is displayed, and controls the second combination service information, where the account service information respectively corresponding to the other user accounts except the logout user accounts, to be displayed.

For example, if it is determined that the user account C logs out in the state that the combination service information where the account service information corresponding to a user A, a user B and a user C are combined with respect to the account service, the controller 140 controls the second combination service information, where the account service information corresponding to the users A and B are combined except or excluding the account service information corresponding to the user account C, to be displayed. That is, the account service information of user account C is not displayed.

According to an exemplary embodiment, the controller 140 determines whether the account addition command is input through the user input section 110 with regard at least one user different from the login user, and controls the combination service information to be displayed when the account addition command is input.

For example, the controller 140 may receive a command of adding a user B with regard to the account service through the user input section 110 after the user account A logs in with regard to the account service.

The controller 140 requests the server to give the combination service information, where the account service information respectively corresponding to a user A and a user B are combined, when the account addition command is input for the user B, and controls the combination service information to be received and displayed.

Here the controller 140 refers to login information of the user account B stored in a storage section (not shown) when receiving a command of adding the user B, and requests the account service server to offer the account service.

Also, the controller 140 may determine whether the account exclusion command is input or not with regard to at least one among a plurality of users in the state that the combination service information corresponding to the plurality of users is displayed.

The controller 140 may control the second combination service information, where the account service information respectively corresponding to the other user accounts except a user account corresponding to the determined account exclusion command are combined, to be displayed.

For example, if an account exclusion command for excluding a user C is input in the state that the combination service information where the account service information corresponding to the users A, B and C are combined is displayed with regard to the account service, the controller 140 may control the second combination service information, where the account service information corresponding to the other users A and B except the account service information corresponding to the user account C are combined, to be displayed. That is, the information of account C is not displayed.

According to an exemplary embodiment, the display apparatus 100 may further include a combination service information generator (not shown).

If it is determined to display the combination service information corresponding to a plurality of users, the controller 140 receives the account service information respectively corresponding to the plurality of users from the server, and controls the combination service information generator (not shown) to combine the received account service information and generate the combination service information.

For example, the controller 140 receives information corresponding to the user account A from the servicer when the user account A logs in with regard to the account service, and then receives information corresponding to the user account B from the server when it is determined that the user account B logs in, thereby controlling the combination service information generator (not shown) to generate and display the combination service information where the account service information corresponding to the users A and B are combined.

According to an exemplary embodiment, the combination service information may include at least one of time combination service information and space combination service information.

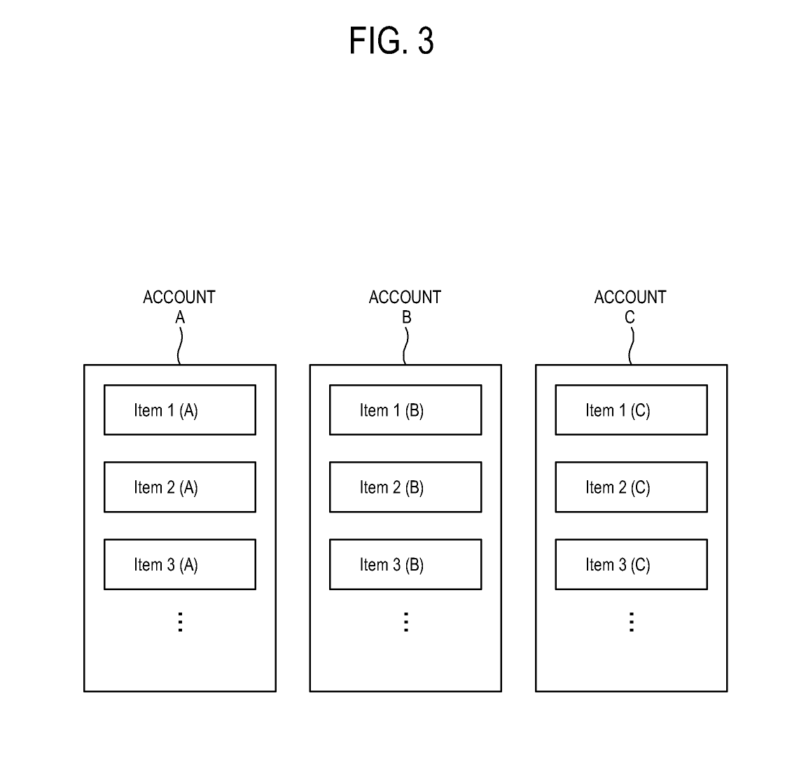

Below, the combination service information according to an exemplary embodiment will be described with reference to FIGS. 3 to 8.

FIG. 3 shows an example of a screen on which the account service information respectively corresponding to the user account A, the user account B and the user account C are displayed in time lines when the user account A, the user account B and the user account C respectively log in.

Here, items may be displayed in respective time lines in order of time of display as the account service information corresponding to the respective user accounts. For example, the respective items may include a text, a photograph, an image, etc.

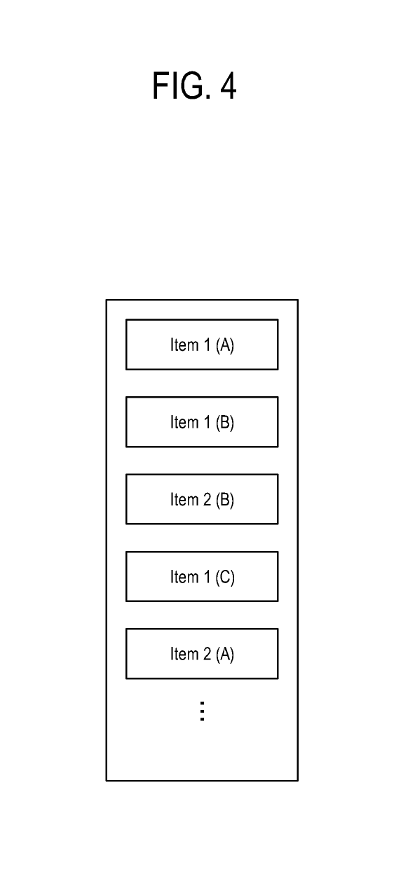

FIG. 4 shows an example of a screen on which time combination service information is displayed as the combination service information where the account service information of the user account A, the user account B and the user account C are combined.

That is, as shown in FIG. 4, the time combination service information is displayed as the items corresponding to the respective user accounts are combined in order of time in one common time line.

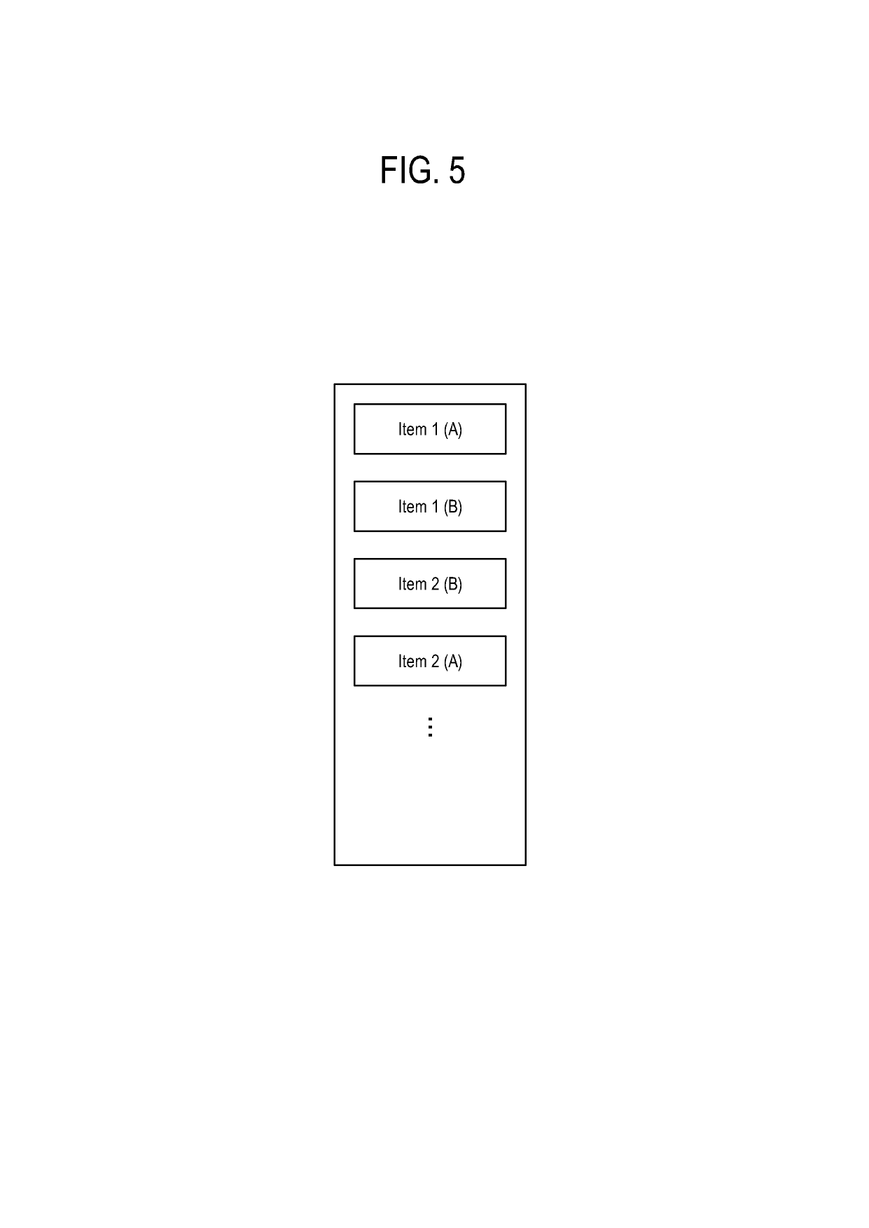

FIG. 5 shows an example of a screen on which the second combination service information according to an exemplary embodiment is displayed.

That is, if the account exclusion command for a user C is input in the state when the display is as in FIG. 3 the combination service information corresponding to the user account A, the user account B and the user account C are displayed as shown in FIG. 4, the second combination service information including only the items corresponding to the user account A and the user account B except the items corresponding to the user account C is displayed.

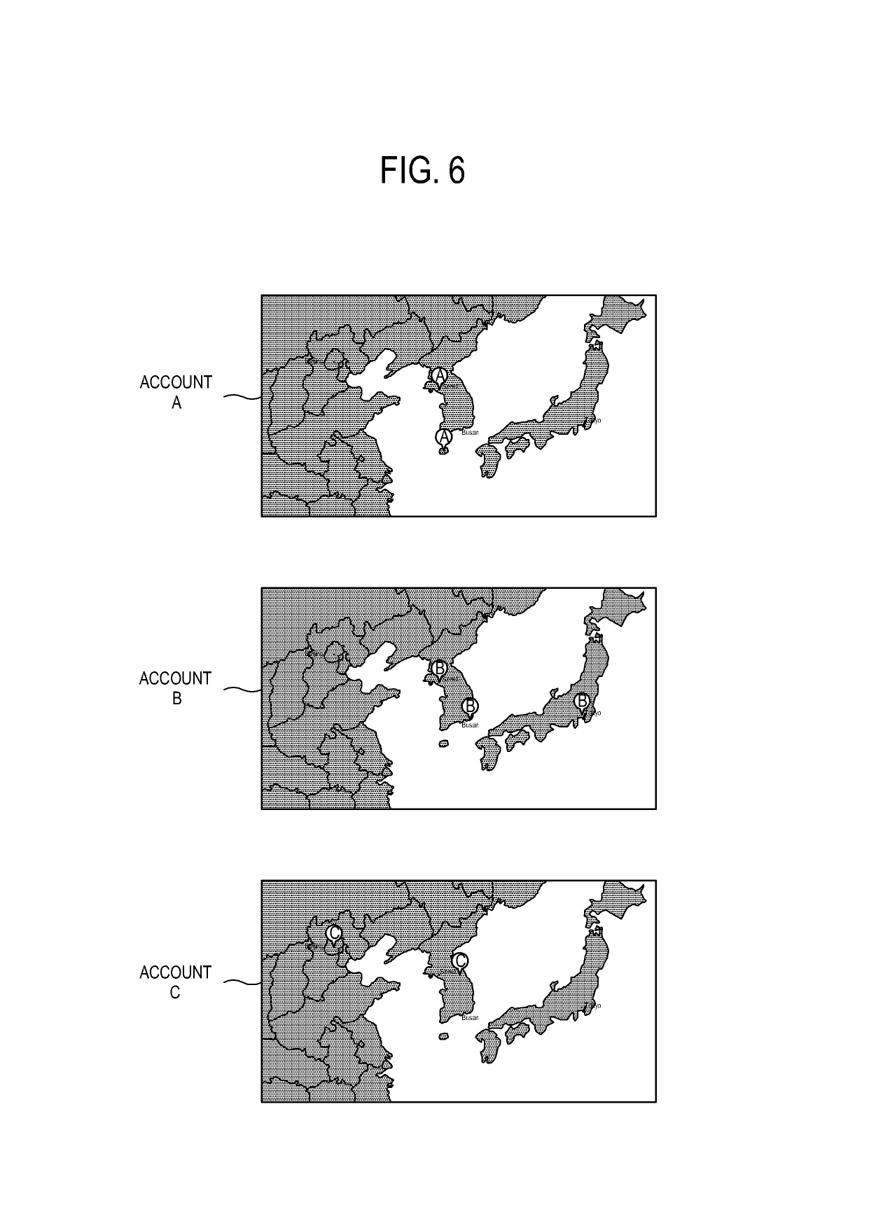

FIG. 6 shows an example of a screen on which the account service information respectively corresponding to the user account A, the user account B and the user account C is displayed on space diagram or view when the respective user accounts log in.

Here, the respective items includes photographs containing positioning information as the account service information corresponding to the respective user accounts, and the positions where the respective photographs are taken may be displayed on a map.

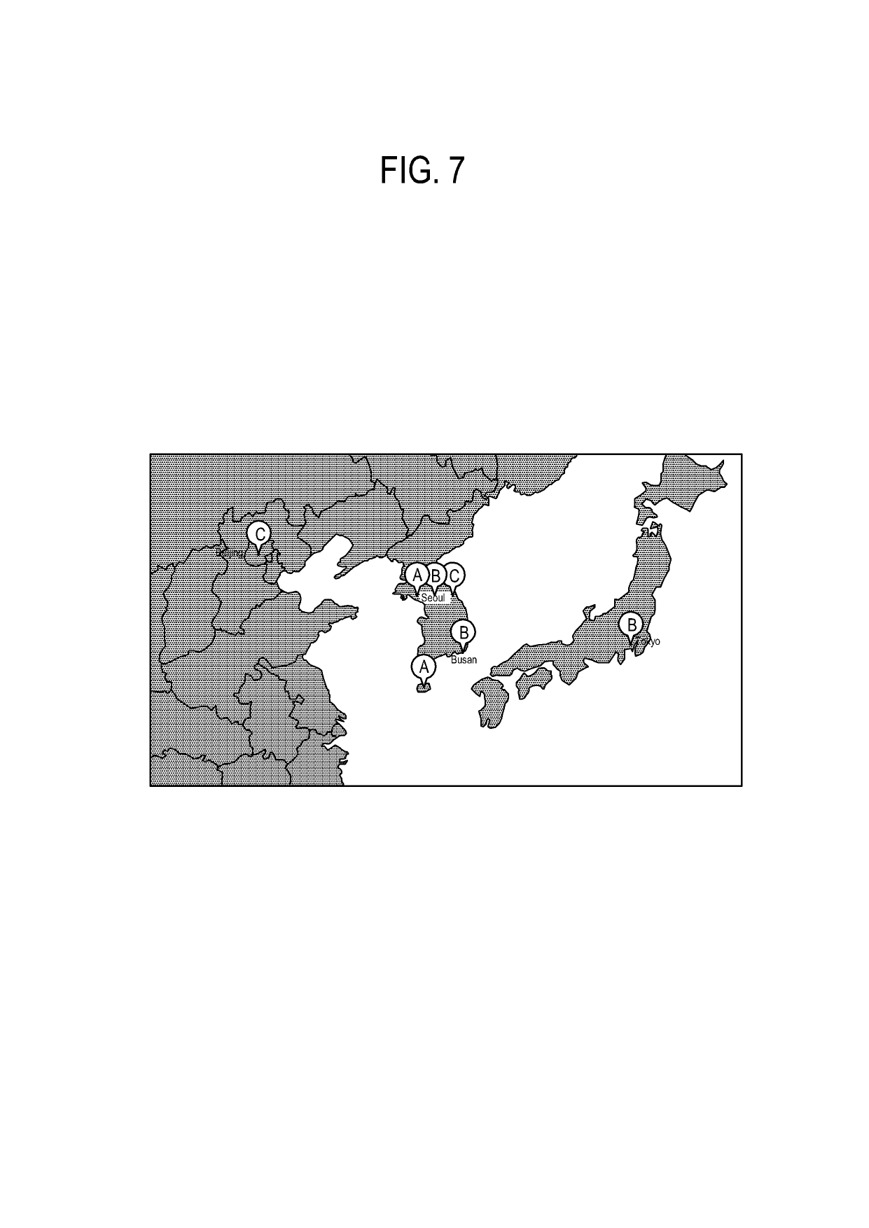

FIG. 7 shows an example of a screen on which space combination service information is displayed as the combination service information where the account service information of the user account A, the user account B and the user account C are combined.

That is, as shown in FIG. 7, the space combination service information may include items corresponding to the respective user accounts displayed on a common space, for example, on a map.

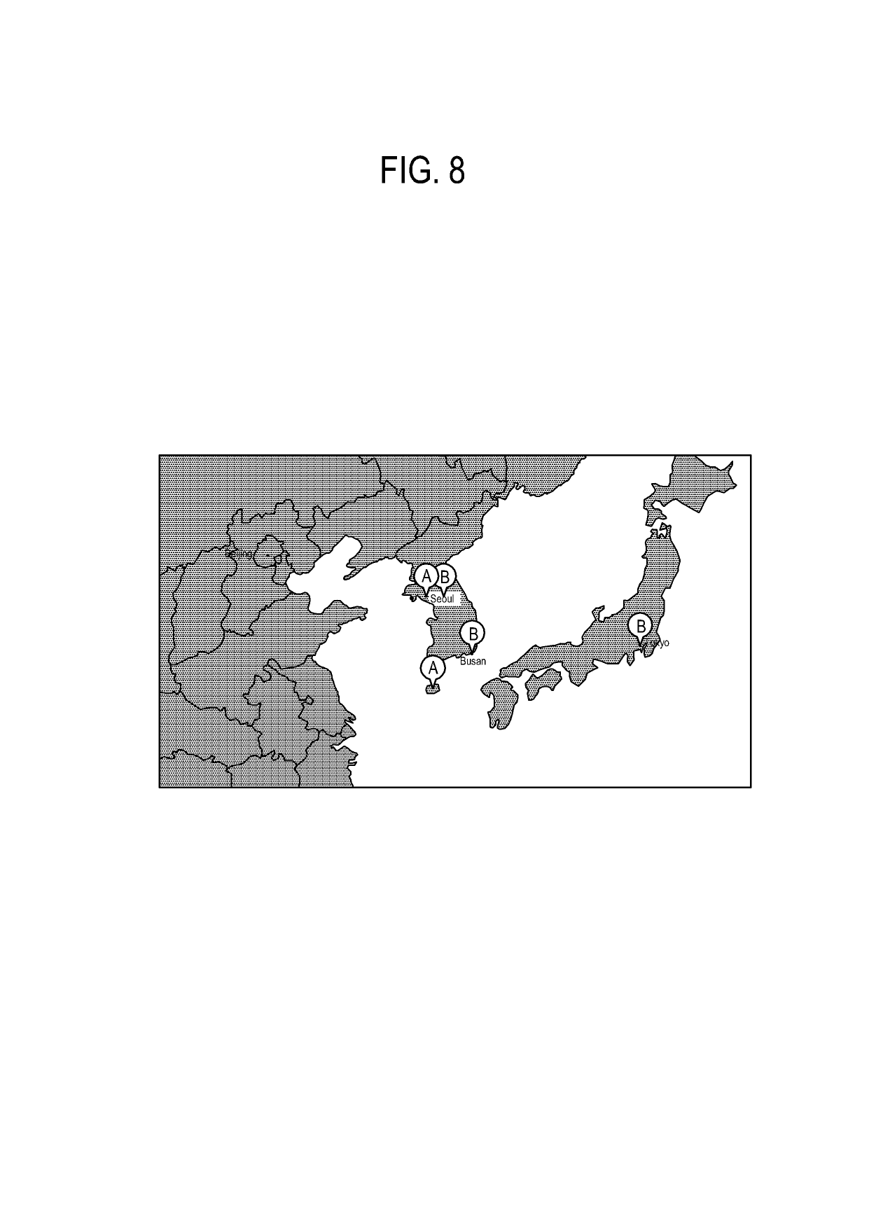

FIG. 8 shows an example of a screen on which the second combination service information according to an exemplary embodiment is displayed.

That is, if the user account C logs out or the account exclusion command for a user C is input in the state that the combination service information corresponding to the user account A, the user account B and the user account C are displayed on one map as shown in FIG. 7, the second combination service information from which items corresponding to the user account C are excluded and which includes only items corresponding to the user account A and the user account B may be displayed.

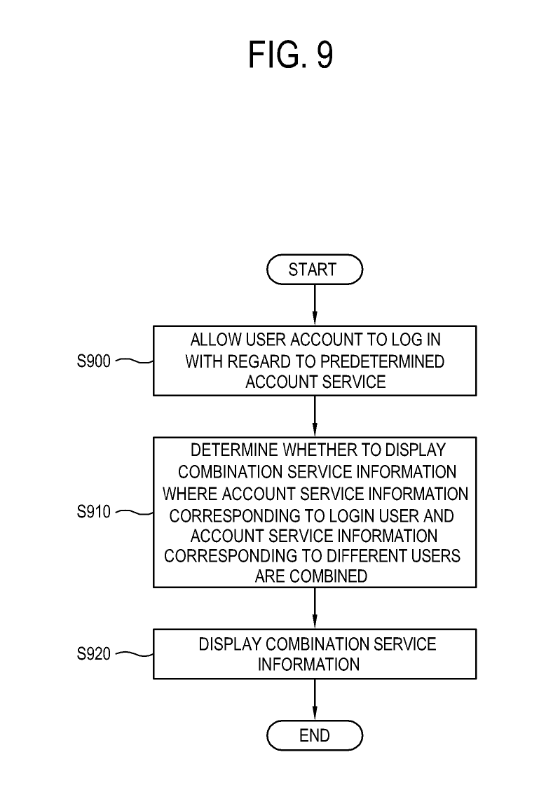

Below, a control method for the display apparatus according to an exemplary embodiment will be described with reference to FIGS. 2 and 9.

As shown in FIG. 9, at operation 5900, login of a user account by a user with regard to a predetermined account service is received through the user input section 110.

Next, at operation s910, the controller 140 determines whether to display the combination service information where the account service information corresponding to the login user and the account service information corresponding to at least one user different from the login user are combined.

Here, the determination about whether to display the combination service information may include determining whether at least one user account different from the login user logs in with regard to the account service.

Alternatively, the determination about whether to display the combination service information may include determining whether to display the combination service information based on the account addition command input through the user input section 110 for at least one user different from the login user.

Then, the controller 140 controls the combination service information, where the account service information corresponding to one user and the account service information corresponding to at least one user different from the one user are combined, to be received from the server 200 of FIG. 1 offering the account service.

Alternatively, the controller 140 controls the account service information corresponding to one user and the account service information corresponding to at least one user different from one user to be respectively received from the server 200, and controls the combination service information generator to generate the combination service information based on the respectively received account service information.

Here, the combination service information may include at least one of the time combination service information and the space combination service information.

Next, at operation 5920, the controller 140 controls the display section 130 to display the combination service information based on the determination.

Also, the controller 140 determines whether at least one of the login user account and at least one user account different from the login user logs out, and controls the second combination service information, where the account service information respectively corresponding to the other user accounts excluding the logout user account are combined, to be displayed.

Alternatively the controller 140 determines whether the account exclusion command is input for the login user and at least one user different from the login user, and controls the second combination service information, where the account service information respectively corresponding to the other user accounts except the user accounts corresponding the account exclusion command are combined, to be displayed.

As described above, according to an exemplary embodiment, there are provided a display apparatus and a control method of the same, in which if a plurality of users activate accounts with regard to a predetermined account service, account service contents can be shared among the plurality of users.

Some example embodiments of the disclosure can also be embodied as a computer readable medium including computer readable code/instruction to control at least one component of the above-described example embodiments. The medium may be any medium that can storage and/or transmission the computer readable code.

Aspects of the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA). Some or all of the operations performed according to the above-described example embodiments may be performed over a wired or wireless network, or a combination thereof.

Although a few exemplary embodiments have been shown and described, it will be appreciated by those skilled in the art that changes may be made in these exemplary embodiments without departing from the principles and spirit of the embodiments. Therefore, the foregoing has to be considered as illustrative only. The scope herein is defined in the appended claims and their equivalents. Accordingly, all suitable modification and equivalents may fall within the scope of the invention.

What is claimed is:

1. A method of controlling a display apparatus, the method comprising:
allowing a user to log in to a user account with regard to an account service;
determining whether to display combination service information where account service information corresponding to the user and account service information corresponding to at least one user different from the user are combined; and
displaying the combination service information based on the determining.

2. The method according to claim 1, wherein the determining whether to display the combination service information determines whether a user account of the at least one user is different from that of the user that logs in with regard to the account service.

3. The method according to claim 2, further comprising:
determining whether the user of the user account and the at least one user different from the user of the at least one user account different from the user logs out; and
displaying second combination service information where the account service information respectively corresponding to another user accounts except the user account that logs out are combined.

4. The method according to claim 1, wherein the determining whether to display the combination service information comprises determining whether to display the combination service information based on an account addition command input through a user input section for the at least one user different from the user.

5. The method according to claim 4, further comprising:
determining whether an account exclusion command is input for the user and the at least one user different from the user; and
displaying second combination service information where the account service information respectively corresponding to other user accounts, except a user account corresponding to the account exclusion command, are combined.

6. The method according to claim 1, further comprising:
receiving the combination service information, where the account service information corresponding to the user and the account service information corresponding to the at least one user different from the user are combined, from a server offering the account service.

7. The method according to claim 1, further comprising:
respectively receiving, as received account service information, the account service information corresponding to the user and the account service information corresponding to the at least one user different from the user from a server offering the account service; and
generating the combination service information based on the received account service information.

8. The method according to claim 1, wherein the combination service information comprises at least one of time combination service information and space combination service information.

9. A display apparatus, comprising:
a communication section which communicates with a server offering an account service;
a user input section which receives a login by a user of a user account with regard to the account service;
a controller which makes a determination as to whether to display combination service information where account service information corresponding to the user and account service information corresponding to at least one user different from the user are combined; and
a display section which displays the combination service information based on the determination.

10. The display apparatus according to claim 9, wherein the controller determines whether at least one user different from the user of the at least one user account different from the user logs in with regard to the account service, and controls the combination service information to be displayed when the at least one user different from the user of the at least one user account different from the user logs in with regard to the account service.

11. The display apparatus according to claim 10, wherein the controller determines whether the user and the at least one user different from the user logs out as a logout account, and controls second combination service information, where account service information respectively corresponding to other user accounts except the determined logout account are combined, to be displayed.

12. The display apparatus according to claim 9, wherein the controller determines whether an account addition command is input for at least one user different from the login user logged-in through the user input section, and controls the combination service information to be displayed when the account addition command is input.

13. The display apparatus according to claim 12, wherein the controller determines whether an account exclusion command is input for the user and the at least one user different from the user through the user input section, and controls second combination service information, where account service information respectively corresponding to other user accounts except a user account corresponding to the account exclusion command are combined, to be displayed.

14. The display apparatus according to claim 9, wherein the controller controls the communication section to receive the combination service information, where the account service information corresponding to the user and the account service information corresponding to the at least one user different from the user are combined, from a server offering the account service.

15. The display apparatus according to claim 9, further comprising a combination service information generator, wherein
the controller controls the communication section to receive account service information as received account service information corresponding to the user and account service information corresponding to the at least one user different from the user respectively from a server offering the account service, and controls the combination service information generator to generate the combination service information based on the received account service information of respective users.

16. The display apparatus according to claim 9, wherein the combination service information comprises at least one of time combination service information and space combination service information.

17. A non-transitory computer readable storage storing a method of controlling a display, the method comprising:
allowing a first user to log in with regard to a service;
determining whether to display combination service information where service information corresponding to the first user and service information corresponding to a second user different from the first user are combined; and
displaying the combination service information based on the determining.

18. A storage according to claim 17, further comprising allowing the second user to log out and the combination service information of other users is displayed.

19. A storage according to claim 17, further comprising allowing the first user to enter an exclusion command and the combination service information of non-excluded users is displayed.

20. A storage according to claim 17, wherein the displaying displays the combination service information one of spatially and temporally.

21. A method, comprising:
allowing users to log in to a server to obtain information from the server; and
displaying a spatial relationship of the users on a map.

22. A method, comprising:
allowing users to log in to a server to request information from the server; and
displaying a temporal relationship of user requests on a time line.
